(19) United States
(12) Patent Application Publication
(10) Pub. No.: US 2017/0225667 A1
(43) Pub. Date: Aug. 10, 2017

(54) ELECTRONIC BRAKE SYSTEM FOR A VEHICLE

(71) Applicant: WABCO GmbH, Hannover (DE)

(72) Inventors: Rainer RISSE, Pattensen-Reden (DE); Axel STENDER, Hameln (DE)

(21) Appl. No.: 15/519,224

(22) PCT Filed: Oct. 9, 2015
(86) PCT No.: PCT/EP2015/001995

§ 371 Date: Apr. 14, 2017

(30) Foreign Application Priority Data
Oct. 14, 2014 (DE) 10 2014 015 132.8

(51) Int. Cl. B60T 8/17; B60R 16/023; B62D 63/08; B60T 13/66

(52) U.S. Cl. CPC B60T 8/1708; B60T 13/66; B60R 16/023; B62D 63/08; B60T 2240/03; B60T 2210/36

(57) ABSTRACT

Disclosed is an electronic brake system for a vehicle, the electronic brake system including one or more electronic components, with at least one electronic control unit. The electronic brake system also includes one or more devices for establishing wireless communications. In the electronic brake system, at least one of the devices for establishing wireless communications is integrated within one of the electronic components or in a unit that contains one of the electronic components.

### CROSS-REFERENCE TO RELATED APPLICATIONS

This application is the National Stage of International Application No. PCT/EP2015/001995, filed on 9 Oct. 2015, which claims priority to and all advantages of German Patent Application No. 10 2014 015 132.8, filed on 14 Oct. 2014, the content of which is hereby incorporated by reference.

### FIELD OF THE INVENTION

The invention generally relates to an electronic brake system for a vehicle and, more specifically, to an electronic brake system including one or more electronic components and one or more devices for establishing wireless communications.

### BACKGROUND OF THE INVENTION

Modern commercial vehicles are equipped with an electronic brake system (EBS). An essential component thereof is an electronic control unit, also referred to as an ECU. Final control elements, sensors and other electronic units are connected to the ECU, either directly or via a data bus connection, in particular via a CAN bus.

Devices for establishing wireless communications can also be connected to the ECU, for example to establish connections by mobile radio (GSM, UMTS, LTE or others), by W-LAN, by Bluetooth or via a 433 MHz module. A connection from the ECU of an electronic brake system to a device for establishing wireless communications is disclosed in WO 2013/124731 A1.

The ECU of the electronic brake system can be combined with pneumatic elements for actuating pneumatic brakes and is then also referred to as a modulator.

Trailer vehicles with electronic brake systems can comprise a dedicated display and operating unit. This is also referred to as a smartboard. For example, pressures and other data available via the data bus connection are displayed, e.g. pressures or tire pressures occurring in a pneumatic suspension system. Data can be read out via such a unit, such as the mileage or even diagnostic messages, and trailer functions are also controlled via such a unit, such as the electronic pneumatic suspension, see EP2057031 B1.

There is typically an electrical connection according to ISO 11992 between a trailer vehicle and a towing machine. A suitable connector is provided on the trailer vehicle side. The connector can be integrated within a housing on an end face of the trailer vehicle, wherein the housing can accommodate further connectors or components. Such a housing is also referred to as a nosebox. A nosebox for accommodating the electrical connectors for the connection between the trailer vehicle and the towing machine is disclosed in U.S. Pat. No. 7,435,093 B1.

The ECU, modulator, smartboard, nosebox and similar units are considered to be electronic components in the context of the present invention. The object of the present invention is the reduction of the parts or the complexity in an electronic brake system.

### SUMMARY OF THE INVENTION

The present invention provides an electronic brake system. The electronic brake system comprises one or more electronic components with at least one electronic control unit, and one or more devices for establishing wireless communications. At least one of the devices for establishing the wireless communications is integrated within one of the electronic components. One of the devices can also be integrated within a unit that contains one of the electronic components, for example in a modulator. A considerable reduction in the cost of the system overall is possible with the described integration, namely by saving additional housings, interfaces and/or controllers.

The electronic components are typically connected to a data bus, in particular to a CAN bus. The aim is the possibility of a data exchange with all connected electronic components and possibly also devices for establishing wireless communications.

In certain embodiments, the electronic control unit is part of a modulator for the brake system, wherein at least one of the devices for establishing the wireless communications is integrated within the modulator. This enables short and fixedly defined signal paths between the control unit and the devices.

In these or other embodiments, a display and operating unit is provided as electronic components, wherein at least one of the devices for establishing the wireless communications is integrated within the display and operating unit. Because the display and operating unit is easily accessible as a result of the function thereof, the integrated device for wireless communications is also easily accessible. This particularly increases the maintenance-friendliness and the possibility of replacing parts.

In certain embodiments, a nosebox can be provided as electronic components, wherein at least one of the devices for establishing the wireless communications is integrated within the nosebox. Because the nosebox is typically disposed on an end face of the trailer vehicle, good wireless communications with transmitters and receivers on the towing machine are possible. There is also good access to the nosebox from the outside. In certain embodiments, the nosebox is connected to the electronic control unit via an interface according to ISO 11992.

In various embodiments, at least one of the following devices is provided as a device for establishing wireless communications:
a) a WLAN module,
b) a telematics module, in particular with a navigation function (GPSGalileo, Glonass, etc.) and a mobile radio function (GSM, UMTS, LTE etc.),
c) a tire pressure monitoring module, and/or
d) a Bluetooth module.

Such modules are provided for establishing and for operating wireless communications. The manner of operation of the module is known. For example, the tire pressure monitoring module generally operates with a frequency of 433 MHz and receives signals from tire pressure sensors that are disposed on the tires of the vehicle.

In various embodiments, the telematics module is integrated within a modulator for the electronic brake system. The modulator also contains the electronic control unit for the electronic brake system. This results in a very short and reliable signal path between the electronic control unit and the telematics module.

In various embodiments, the WLAN module is integrated within the modulator for the electronic brake system, optionally also in addition to the integration of a telematics module. The very short and reliable signal path is a particular advantage here too.

In these or other embodiments, the tire pressure monitoring module is integrated within the modulator for the electronic brake system, possibly also together with one of the other modules.

In specific embodiments, the telematics module and/or the WLAN module are integrated within the nosebox. This enables particularly reliable wireless communications between the trailer vehicle and the towing machine.

In certain embodiments, the WLAN module is integrated within the display and operating unit. In this case, it is a particularly maintenance-friendly configuration.

Besides the combinations mentioned, all other combinations of electronic components and devices for establishing the wireless communications are possible and can be used advantageously for the purposes of the invention.

Advantageously, vehicle data can be read out and/or vehicle functions can be controlled via the wireless interface, for example by smartphone or with another suitable remote station for wireless communications.

The present invention also provides a vehicle with an electronic brake system according to the invention, as described above. In particular, it is a trailer vehicle, for example a semitrailer, typically with a nosebox. The invention is however not limited to trailer vehicles. Towing machines or motor vehicles can also be designed according to the invention.

The present invention further provides a modulator for an electronic brake system. The modulator comprises an electronic control unit. At least one of the following devices is integrated with the modulator:
a) a WLAN module,
b) a telematics module, in particular with navigation and mobile radio functions,
c) a tire pressure monitoring module, and/or
d) a Bluetooth module.

Additionally, the present invention provides a display and operating unit for an electronic brake system. At least one of the following devices is integrated within the display and operating unit:
a) a WLAN module,
b) a telematics module, in particular with navigation and mobile radio functions,
c) a tire pressure monitoring module, and/or
d) a Bluetooth module.

Further, the present invention provides a nosebox for a trailer vehicle with an electronic brake system. At least one of the following devices is integrated within the nosebox:
a) a WLAN module,
b) a telematics module, in particular with navigation and mobile radio functions,
c) a tire pressure monitoring module, and/or
d) a Bluetooth module.

### BRIEF DESCRIPTION OF THE DRAWING

The invention is described in greater detail below with reference to the accompanying figures, in which:

FIG. 1 shows a representation of the prior art, namely a three-axle semitrailer with a nosebox and selected components of an electronic brake system (EBS),

FIG. 2 shows a representation similar to FIG. 1, but with a first exemplary embodiment according to the invention,

FIG. 3 shows a second exemplary embodiment according to the invention,

FIG. 4 shows a third exemplary embodiment according to the invention, and

FIG. 5 shows a fourth exemplary embodiment according to the invention.

### DETAILED DESCRIPTION

Referring to the Figures, wherein like numerals indicate corresponding parts throughout the several views, a semitrailer is generally shown at 10.

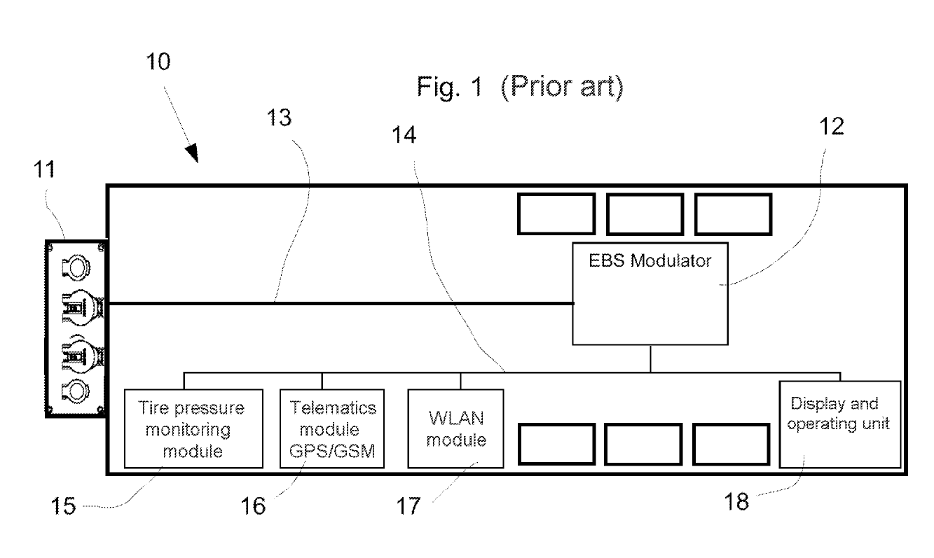

FIG. 1 is prior art and shows a semitrailer 10 with a nosebox 11 equipped with an electronic brake system (EBS) and a modulator 12. The nosebox 11 and the modulator 12 are connected together via a cable 13 according to ISO 11992. Connectors for connection to corresponding connectors of a towing vehicle that is not shown are disposed in the nosebox 11.

The modulator 12 is connected via a CAN bus 14 to different devices for establishing wireless communications, namely to a tire pressure monitoring module 15, a telematics module 16, a WLAN module 17 and a display and operating unit 18. The operation of the latter can be carried out via operating buttons, operating knobs and/or a touch sensitive display screen. The modules 15 through 17 mentioned need their own housing, interfaces and controller.

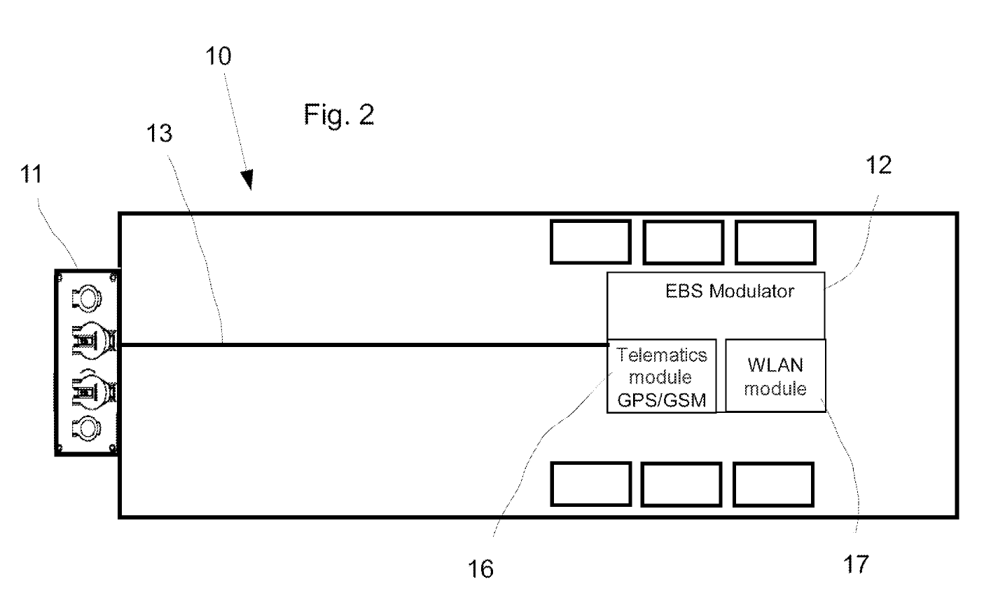

In the four exemplary embodiments according to the invention of FIGS. 2 through 5, the same reference numbers are given as in FIG. 1. In each case the semitrailer 10 is provided with a nosebox 11, a modulator 12 and a cable 13 according to ISO 11992. The further components of the system shown in FIG. 1 are not always marked in FIGS. 2 through 5, but can nevertheless be present. In particular, at least one CAN bus is generally present.

According to the first exemplary embodiment according to the invention (FIG. 2), the telematics module 16 and the WLAN module 17 are integrated within the modulator 12. As a result, the housing, interfaces and controller can be saved compared to the prior art, with a corresponding reduction in the total cost.

Alternatively, only one of the modules 16, 17 can also be integrated within the modulator 12.

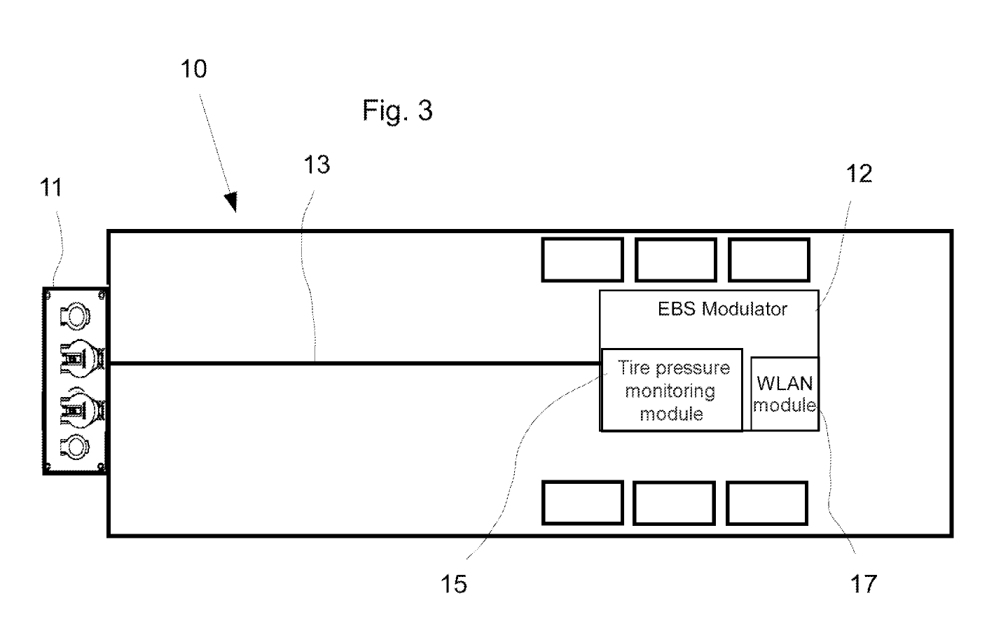

The second exemplary embodiment according to the invention (FIG. 3) is very similar to the first exemplary embodiment. The tire pressure monitoring module 15 and the WLAN module 17 are integrated within the modulator 12. Alternatively, only one of the two modules 15, 17 can also be integrated within the modulator 12.

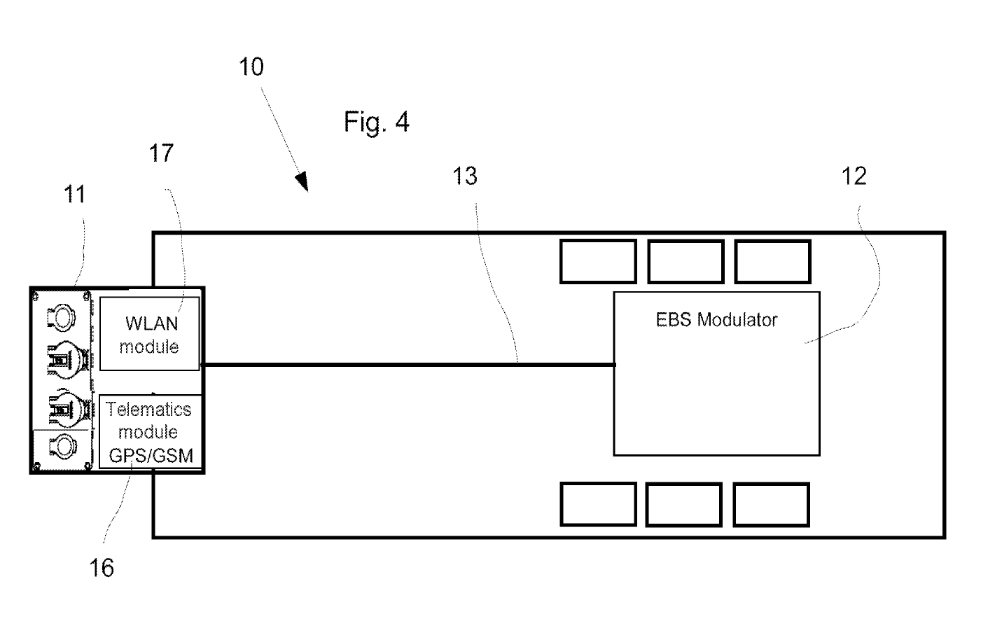

In the third exemplary embodiment according to the invention (FIG. 4), the nosebox 11 is expanded to accommodate the integrated telematics module 16 and the likewise integrated WLAN module 17. In this case, the two modules 16, 17 are connected to the cable 13, via which data can also be transferred. Alternatively, only one of the modules 16, 17 is integrated within the nosebox 11.

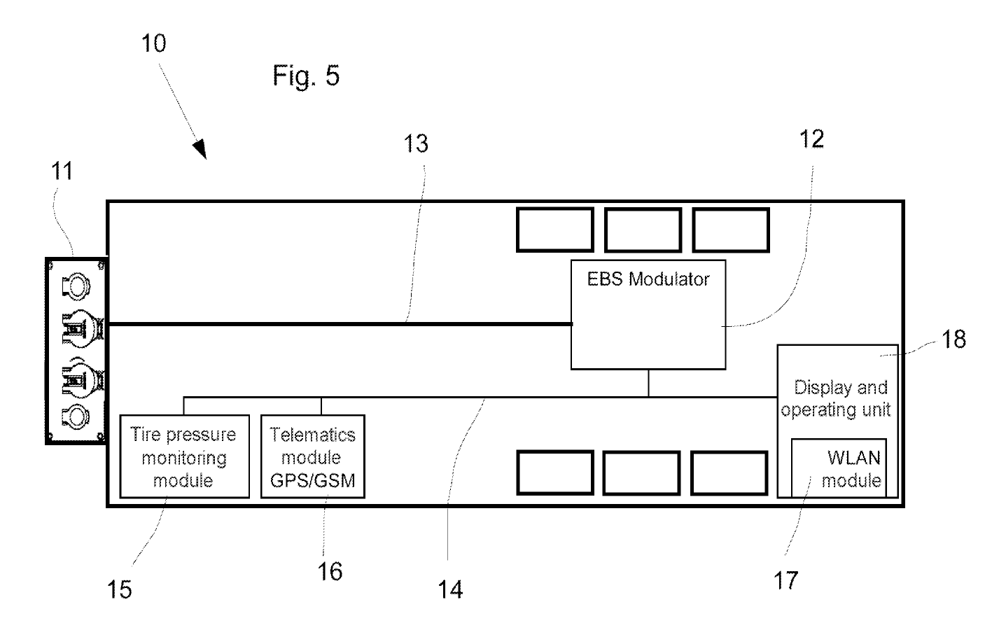

According to the fourth exemplary embodiment according to the invention (FIG. 5), the WLAN module 17 is integrated within the display and operating unit 18. The latter is connected to the CAN bus 14, as are modules 15 and 16.

The parts with the reference numbers 11, 12 and 18 are electronic components of the electronic brake system for the purposes of the invention, whereas modules 15, 16 and 17 are provided as devices for establishing wireless communications. In addition or alternatively, other modules with other wireless transmission technology can be provided, for example modules with Bluetooth radio technology. The tire pressure monitoring module 15 operates typically as a receiver for signals of tire pressure sensors at the frequency 433 MHz.

The exemplary embodiments according to the invention that are shown using FIGS. 2 through 5 are not exhaustive. The modules 15, 16 and 17 or others can be integrated within the electronic components 11, 12, 18 individually or jointly with other modules. Distribution is also possible in such a way that different modules are integrated within different electronic components.

What is claimed is:

1. An electronic brake system for a vehicle, the electronic brake system comprising one or more electronic components with at least one electronic control unit, and one or more devices for establishing wireless communications, wherein at least one of the devices for establishing wireless communications is integrated within one of the electronic components or in a unit that contains one of the electronic components.

2. The electronic brake system as claimed in claim 1, wherein the electronic control unit is part of a modulator for the brake system and that at least one of the devices for establishing the wireless communications is integrated within the modulator.

3. The electronic brake system as claimed in claim 1, wherein a display and operating unit is provided as electronic components and that at least one of the devices for establishing the wireless communications is integrated within the display and operating unit.

4. The electronic brake system as claimed in claim 1, wherein a nosebox is provided as electronic components and that at least one of the devices for establishing the wireless communications is integrated within the nosebox.

5. The electronic brake system as claimed in claim 1, wherein at least one of the following devices is provided as a device for establishing the wireless communications:
a) a WLAN module,
b) a telematics module with a navigation function and a mobile radio function,
c) a tire pressure monitoring module, and
d) a Bluetooth module.

6. The electronic brake system as claimed in claim 5, wherein the telematics module is integrated within a modulator for the electronic brake system.

7. The electronic brake system as claimed in claim 5, wherein the WLAN module is integrated within a modulator for the electronic brake system.

8. The electronic brake system as claimed in claim 5, wherein the tire pressure monitoring module is integrated within a modulator for the electronic brake system.

9. The electronic brake system as claimed in claim 5, wherein the telematics module is integrated within a nosebox.

10. The electronic brake system as claimed in claim 5, wherein the WLAN module is integrated within a nosebox.

11. The electronic brake system as claimed in claim 5, wherein the WLAN module is integrated within a display and operating unit.

12. The electronic brake system as claimed in claim 1, wherein vehicle data can be read out and/or vehicle functions can be controlled via the wireless interface.

13. A vehicle with an electronic brake system as claimed in claim 1.

14. A system, comprising: at least one of a modulator, a display and operating unit, and a nosebox for a trailer vehicle, each being for an electronic brake system with an electronic control unit, wherein at least one of the following devices is integrated within the at least one of the modulator, the display and operating unit, and the nosebox:
a) a WLAN module,
b) a telematics module, in particular with a navigation function and a mobile radio function,
c) a tire pressure monitoring module, and
d) a Bluetooth module.

15. (canceled)

16. (canceled)

17. The system of claim 14, comprising the modulator.

18. The system of claim 14, comprising the display and operating unit.

19. the system of claim 14, comprising the nosebox.
